(19) United States
(12) Patent Application Publication
(10) Pub. No.: US 2026/0326707 A1
(43) Pub. Date: Oct. 22, 2026

(54) BELT RETRACTOR WITH LOAD-TRANSMITTING CATCH

(71) Applicant: ZF AUTOMOTIVE GERMANY GMBH, Alfdorf (DE)

(72) Inventors: Markus BERGMANN, Alfdorf-Pfahlbronn (DE); Stefan EISELE, Wissgoldingen (DE); Markus DAEUBER, Eislingen (DE); Sebastian FISCHER, Rosengarten (DE)

(21) Appl. No.: 19/109,667

(22) PCT Filed: Sep. 4, 2023
(86) PCT No.: PCT/EP2023/074166

§ 371 Date: Mar. 7, 2025

(30) Foreign Application Priority Data
Sep. 8, 2022 (DE) 10 2022 122 816.9

(51) Int. Cl. B60R 22/42

(52) U.S. Cl. CPC B60R 22/42

(57) ABSTRACT

A belt retractor comprises a frame, a belt reel (12) arranged rotatably in the frame, a locking mechanism by which the belt reel (12) can be locked in the frame, and a load limiter which is releasably coupled to the belt reel (12). For coupling the load limiter, at least one load-limiting latch (20) is provided which is arranged on the belt reel (12) and is maintained in a coupling position by a support ring (24), wherein the support ring (24) can be moved out of a support position into a release position by means of an actuator. The support ring (24) includes a contact projection (26) associated with the load-transmitting latch (20) on the side of which the load-transmitting latch (20) abuts with a contact face (56), wherein the contact projection (26) has an expansion in the axial direction which corresponds at least to the expansion of the contact face (56) in the axial direction.

### TECHNICAL FIELD

The invention relates to a belt retractor comprising a frame, a belt reel arranged rotatably in the frame, a locking mechanism by which the belt reel can be locked in the frame, and a load limiter.

### BACKGROUND

A belt retractor of this type is known from WO 2017/174641 A1. It is used to provide a seatbelt to a vehicle occupant of a vehicle. During normal operation, the vehicle occupant can freely extract the seatbelt from the belt reel against the effect of a retractor spring, and the belt reel rewinds the seatbelt when the vehicle occupant unfastens the seatbelt, for example. Depending on external parameters such as the deceleration of the vehicle or the angular acceleration of the belt reel during webbing extraction, the locking mechanism by which the belt reel can be locked in the frame is activated.

When the belt reel is locked in the frame, until a predefined load level is reached in the seatbelt, no further seatbelt webbing can be extracted from the belt reel; the belt reel does not rotate relative to the frame of the belt retractor, apart from minimum yielding that is due to the inherent elasticity of all components provided in the flux of force.

When the predetermined load level is reached, the load limiter becomes active. It enables the belt reel to rotate relative to the frame under the effect of the tensile force of the seatbelt. As a result, a certain amount of seatbelt is released that is available as an additional distance for the deceleration of the vehicle occupant.

From WO 2017/174641 A1, a belt retractor is known in which the connection between a load limiter and a belt reel of the belt retractor is established via at least one load-transmitting latch. For this purpose, the latch is held in a home position by a support ring, wherein, using an actuator, the support ring can be transferred to a release position in which the latch is released and, thus, the contact between the load limiter and the belt reel is released. However, it has turned out that, in particular load conditions, the latches may tilt when they are released from the load limiter so that the type of the load limiters used and the applicable torque are limited.

### SUMMARY

It is the object of the invention to develop the known belt retractor to the effect that the required space is further reduced and the operation of the belt retractor is designed to be even more reliable.

According to the invention, the object is achieved by a belt retractor comprising a frame, a belt reel arranged rotatably in the frame, a locking mechanism by which the belt reel can be locked in the frame, and a load limiter that is releasably coupled to the belt reel. For coupling the load limiter, at least one load-transmitting latch is provided which is arranged on the belt reel and is held by a support ring in a coupling position, wherein the support ring can be moved out of a support position into a release position using an actuator. The support ring has a contact projection associated with the load-transmitting latch on the side which the load-transmitting latch abuts with a contact face, the contact projection having an expansion in the axial direction that corresponds at least to the expansion of the contact face in the axial direction.

Consequently, according to the invention it is provided to adapt the size of the contact projection of the support ring to the size of the contact face of the associated load-transmitting latch. In this way, the load-transmitting latch is efficiently prevented from tilting, as sufficient contact between the contact projection and the load-transmitting latch is safeguarded at any time. As a result, the coupling between the load limiter and the belt reel can be released even more reliably.

In addition, also load limiters that transmit a higher torque can be used without having to worry that this might excessively increase tilting of the load-transmitting latch. At the same time, a rotary movement of the load limiter can be transmitted laterally to the contact projection of the support ring via the load-transmitting latch, and vice versa.

In order to even further optimize the contact between the load-transmitting latch and the support ring, the whole contact face of the load-transmitting latch can abut on the associated contact projection.

Preferably, the contact projection has an expansion in the axial direction which is at least the sum of the expansion of the contact surface of the load-transmitting latch and a release distance, the release distance referring to the distance that results from the difference in position of the support ring in the release position and the support position in the axial direction. This can ensure that the load-transmitting latch abuts with its contact face completely on the associated contact projection both in its coupling position and, after reaching the release position of the support ring, in a decoupling position of the load-transmitting latch.

It is provided in one configuration of the invention that the load-transmitting latch and the associated contact projection of the support ring are arranged in a cutout on the belt reel. In this way, the load-transmitting latch and the contact projection can be driven by the belt reel without taking any further measures with little effort, while at the same time both the load-transmitting latch and the contact projection remain adjustable in the axial direction.

In particular, the belt retractor is arranged to displace the load-transmitting latch radially inside the cutout using the load limiter, once the support ring is moved out of a support position toward a release position. In other words, once the support ring starts to move to the release position, the rotary movement caused by the belt retractor or the load limiter is used to displace the load-transmitting latch in the direction of the decoupling position and, thus, to ensure precise control of the decoupling procedure.

In order to distribute the forces generated to transmit the torques occurring more evenly, several load-transmitting latches can be provided and the support ring for each of the load-transmitting latches can have a contact projection associated with the respective load-transmitting latch.

Accordingly, in this variant each of the load-transmitting latches has a contact face that abuts on the side of each of the associated contact projections.

In particular, two, three or four load-transmitting latches are provided. In this way, a sufficient load distribution is achieved, while at the same time the effort in manufacture does not become excessive and a robust arrangement is obtained.

In particular, the several load-transmitting latches are arranged symmetrically.

Preferably, the load-transmitting latches are arranged at a constant angular distance from each other, that is e.g. at an angular distance of 180 ° from each other in the case of two load-transmitting latches and/or at an angular distance of 120 ° from one another in the case of three load-transmitting latches.

In one configuration, the support ring includes at least one circumferential holding portion by which the support ring is fastened to an extension of the belt reel in the support position. In this way, a reliable connection is created between the support ring and the belt reel so that a torque generated by the belt reel can be transmitted even better to the support ring, while simultaneously keeping the mounting effort low.

In order to fix the support ring reliably in the support position, there can be provided a holding ring which holds the support ring in the support position, the support ring including at least one fastening projection which engages in an associated holding fixture of the holding ring.

The fastening projection is particularly part of the contact projection of the support ring so that the design of the support ring is further simplified.

If several holding fixtures are present, they are distributed particularly symmetrically on the holding ring, in particular at a constant angular distance from one another.

It is also possible that the holding ring additionally includes one or more holding arms which fix the support ring in the axial direction. The holding arms can be particularly resilient so that the support ring and the holding ring can be slipped onto each other with little effort in order to fix the support ring.

The support ring particularly has a symmetric design to further facilitate the assembly of the belt retractor.

### BRIEF DESCRIPTION OF THE DRAWINGS

Further features and characteristics of the invention result from the following description of an exemplary embodiment which is not intended to be understood in a limiting sense, as well as from the drawings, wherein:

FIG. 1 shows a partially exploded view of a belt retractor according to the invention,

FIG. 2 shows a perspective view of a belt reel of the belt retractor of FIG. 1,

FIG. 3 shows a perspective view of a support ring of the belt retractor of FIG. 1,

FIG. 4 shows a longitudinal section across selected parts of the belt retractor of FIG. 1 in a support position of the support ring,

FIG. 5 shows a longitudinal section across a detail of the belt retractor of FIG. 1,

FIG. 6 shows a sectional view across the belt retractor of FIG. 1 in a support position of the support ring,

FIG. 7 shows another perspective view of selected parts of the belt retractor of FIG. 1 in a support position of the support ring,

FIG. 8 shows another perspective view of selected parts of the belt retractor of FIG. 1 analogous to FIG. 7 in a release position of the support ring,

FIG. 9 shows a longitudinal section across selected parts of the belt retractor of FIG. 1 when the support ring passes from the support position into the release position,

FIG. 10 shows a further sectional view across selected parts of the belt retractor of FIG. 1 in the support position of the support ring,

FIG. 11 shows a sectional view along the plane B-B of FIG. 10,

FIG. 12 shows a sectional view analogous to FIG. 10 in the release position of the support ring,

FIG. 13 shows a sectional view along the plane B-B of FIG. 12,

FIG. 14 shows a detail view of the representation of FIG. 13,

FIG. 15 shows a detail view analogous to FIG. 14 with the load-transmitting latch in the decoupling position, and

FIG. 16 shows a perspective view of the decoupling position of the load-transmitting latch.

### DESCRIPTION

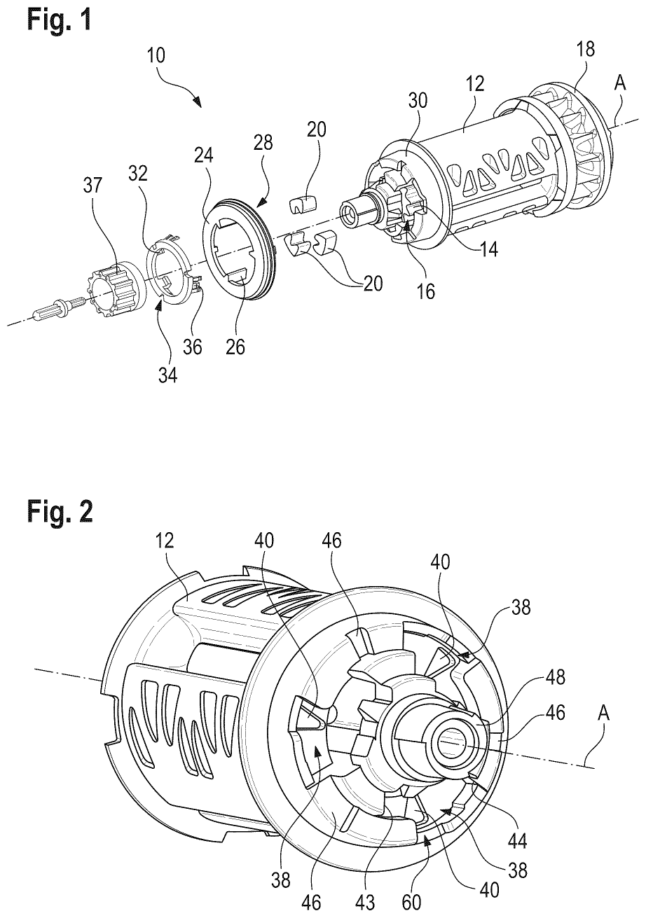

FIG. 1 illustrates a partly exploded view of a belt retractor 10 according to the invention, wherein the representation of components which are not necessary for the comprehension of the invention and are generally known, was substantially omitted in order to facilitate the comprehension of the invention.

The belt retractor 10 comprises a belt reel 12 that is arranged in a frame (not shown). The frame is used as a load-bearing component for the belt reel 12.

A torsion rod 14 which is the core component of a load limiter 16 of the belt retractor 10 extends through the belt reel 12. The torsion rod 14 at one end (shown on the left in FIG. 1) is associated with the belt reel 12 and at the other hand (shown on the right in FIG. 1) is received to be rotationally fixed in a hub (not shown). Further, a drive wheel 18 upon which a so-called pre-tensioner such as an electric motor, or a main tensioner such as a main tensioner on the basis of pyrotechnical charge, can act is connected to the hub in a rotationally fixed manner.

A locking mechanism (not shown) which is used to lock the hub in relation to the frame, if needed, is arranged in turn on the drive wheel 18, and thus also on the hub.

The operating mode and the effects of the pre-tensioner and of the locking mechanism are generally known, and, in this context, reference is made by way of example to the explanations in WO 2017/174641 A1.

The belt retractor 10 comprises several load-transmitting latches 20 which are arranged in the belt reel 12 so that the load-transmitting latches 20 with their respective tips 22 engage in driving teeth 23 of the torsion rod 14 (see FIG. 6).

This position of the load-transmitting latches 20 will also be referred to as “coupling position” in the following.

The latches 20 are held by a support ring 24 in the coupling position when the support ring 24 is in a support position. Hereinafter, the operating mode of the support ring will be explained in more detail.

The support ring has several contact projections 26, for each of the load-transmitting latches 20 an associated contact projection 26 being provided.

Further, the support ring 24 includes a circumferential holding portion 28, the holding portion 28 having a radial inner diameter that is larger than the diameter of an extension 30 of the belt reel 12 (see FIG. 2) so that the support ring 24 can be slipped with the holding portion 28 onto the extension 30 of the belt reel 12.

The belt retractor 10 further has a holding ring 32 which holds the support ring 24, the holding ring 32 including several holding fixtures 34 which are complementary to the contact projections 26 of the support ring 24, wherein each of the holding fixtures 34 is associated with one of the contact projections 26. In this way, the correct alignment of the support ring 24 relative to the holding ring 32 is ensured by the interaction of the contact projections 26 and the holding fixtures 34. In other words, the part of the contact projections 26 facing toward the holding ring 32 constitutes fastening projections 35 for the holding ring 32.

The holding ring 32 further has several holding arms 36 which axially fix the support ring 24.

In addition, the belt retractor 10 includes a toothing element 37 that is connected to the belt reel 12 and onto which the support ring 24 and the holding ring 32 are slipped.

As can be seen from FIG. 1, all component parts of the belt retractor 10 are designed so that, for the purpose of assembly, they can be slipped onto one another along a central axis A so that the manufacturing effort of the belt retractor 10 is minimized and a particularly compact design is made possible.

The central axis A moreover defines an axial direction of the belt retractor 10.

FIG. 2 illustrates a perspective view of the belt reel 12.

It can be seen from this view that several cutouts 38 are provided at the end of the extension 30 of the belt reel 12 facing toward the support ring 24.

One of the load-transmitting latches 20 and the contact projection 26 of the support ring 24 associated with the respective load-transmitting latch 20 are received in each of the cutouts 38.

Accordingly, the number of the cutouts 38 is adapted to the number of load-transmitting latches 20.

It is understood that also fewer or more of the latches 20 can be provided, a plurality of latches 20, specifically two, three or four latches 20, being of particular advantage to allow a particularly even load distribution when the belt retractor 10 is operated.

In each of the cutouts 38 moreover a depression 40 is provided in which a lower side 42 of the contact projection 26 received in the respective cutout 38 engages in a home position of the support ring 24 that is also referred to as support position.

Each of the cutouts 38 is delimited along a direction of rotation R (see FIG. 11) by a first sidewall 43 and a second sidewall 44.

In addition, aligning depressions 46 are provided between the depressions 40 along the circumference of the extension 30 of the belt reel 12. In other words, each of the aligning depressions 46 is positioned on the bisecting line between two of the depressions 40.

Further, the belt reel 12 includes a mounting extension 48 onto which the toothing element 37 is slipped and is fastened in a rotationally fixed manner.

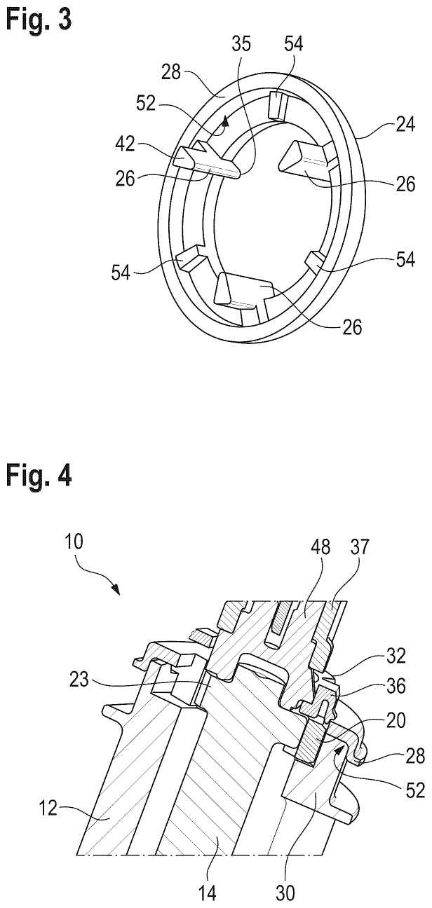

FIG. 3 illustrates a perspective view of the support ring 24, wherein a view of a lower side 50 of the support ring 24 is chosen, i.e., of the side which faces in the direction of the belt reel 12 in the mounting position.

It can be seen from this representation that the contact projections 26 protrude on both sides in the axial direction, wherein the lower sides 42 which engage in the depressions 40 of the belt reel 12 protrude on the side facing the belt reel 12, and the fastening projections 35 project on the side facing the holding ring 32 so that they can interact with the holding fixture 34.

Moreover, it can be seen from FIG. 3 that a recess 52 by which a contact is made between the support ring 24 and the extension 30 after slipping the support ring 24 onto the extension 30 of the belt reel 12 is provided by the circumferential holding portion 28.

In addition, the support ring 24 includes aligning elements 54 which, in the shown embodiment, are each arranged at half the angular distance between two of the contact projections 26 and engage in the aligning depressions 46 of the extension 30 in the support position of the support ring 24.

FIG. 4 illustrates a sectional view of selected parts of the belt retractor 10, with the support ring 24 being in its support position.

It can be seen from this representation in which way the circumferential holding portion 28 encompasses the extension 30 of the belt reel 12 so that the extension 30 is received in the recess 52.

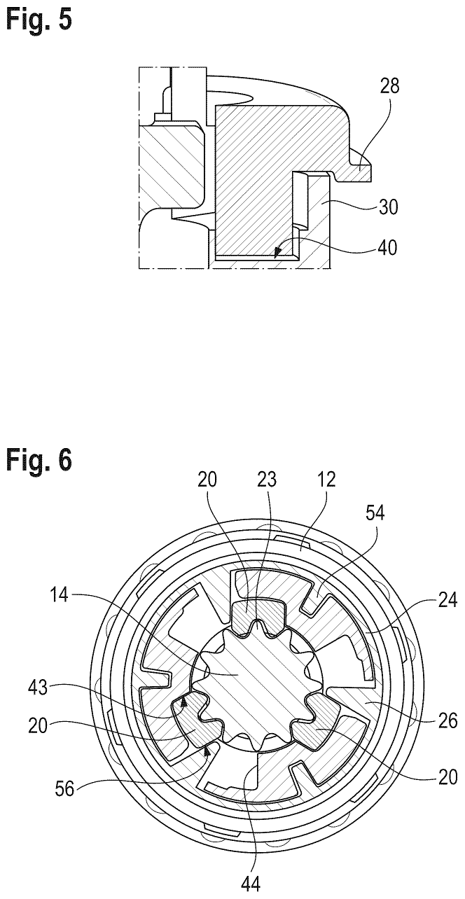

It can moreover be seen that the contact projections 26 extend so far into the cutout 38 that the lower side of the contact projections 26 comes to be located in the depressions 40, as is shown more clearly in the representation in FIG. 5 which shows a further sectional view level with one of the depressions 40 in more detail.

From FIG. 4, moreover the interaction between the support ring 24 and the holding ring 32 becomes clear. The holding arms 36 interact both with the support ring 24 and with cutouts 55 of the mounting extension 48 to fix the support ring 24 in the axial direction.

FIG. 6 illustrates a further sectional view transversely across the extension 30 level with the cutout 38 at a point in time when the support ring 24 is in its support position and, thus, the load-transmitting latches 20 are in their coupling position.

In this configuration, each of the load-transmitting latches 20 abuts with a contact face 56 on the side of the associated contact projection 26 and, on the opposite side of the contact face 56, abuts on the first sidewall 43 of the respective cutout 38.

The tips 22 of the load-transmitting latches 20 interact with the driving teeth 23 of the torsion rod 14. In this way, rotary movements of the load-transmitting latches 20 can be transmitted to the torsion rod 14 just as rotary movements of the torsion rod 14 can be transmitted to the load-transmitting latches 20.

It can moreover be seen from FIG. 6 that the aligning elements 54 of the support ring 24 are arranged in each of the associated aligning depressions 46 of the extension 30.

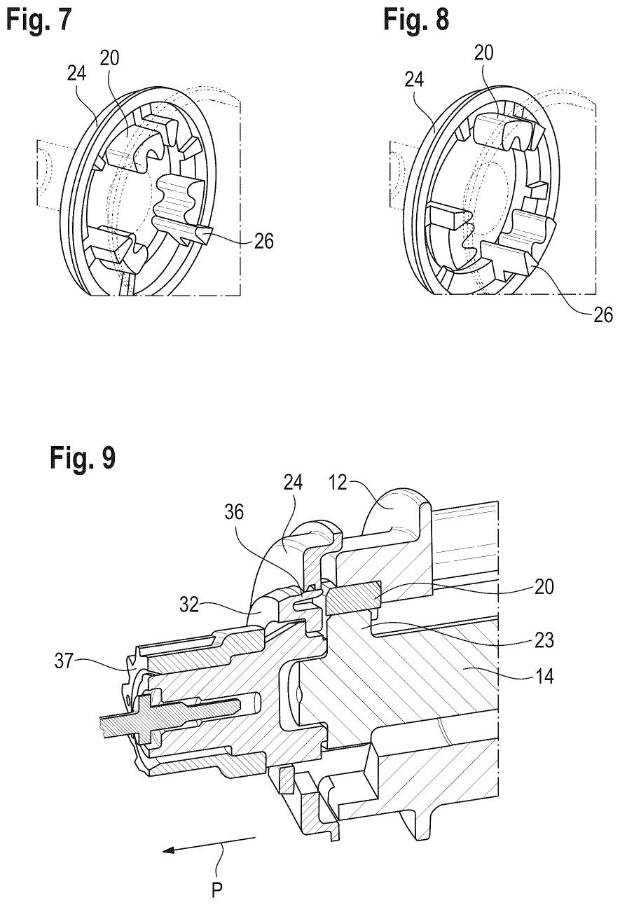

FIG. 7 illustrates a further perspective view of the belt retractor 10 in the support position of the support ring 24, wherein selected components of the belt retractor 10 are shown transparently.

This representation makes clear that the contact projections 26 have such an expansion in the axial direction that the load-transmitting latches 20 abut with their respective contact face 56 completely on the contact projection 26.

FIG. 8 illustrates the same perspective view of the belt retractor 10 as FIG. 7, but after the support ring 24 has turned into a release position in which the load-transmitting latches 20 are no longer in contact with the driving teeth 23 of the torsion rod 14, and thus are in their decoupling position.

As can be seen from FIG. 8, the contact projections 26 in the axial direction have such an expansion that it is ensured that the load-transmitting latches 20 abut with their contact face 56 completely on each of the associated contact projections 26 even in the release position of the support ring 24.

To this end, the contact projections 26 particularly have an axial expansion that is at least the sum of the axial expansion of the respective contact face 56 of the load-transmitting latch 20 and a release distance, the release distance referring to the distance that results from the difference in position of the support ring 24 in the release position and in the support position in the axial direction.

It is achieved in this way that the load-transmitting latches 20 cannot tilt during the switching operation between the support position and the release position of the support ring 24. This allows a particularly reliable operation of the belt retractor 10 and the use of torsion rods 14 having larger diameters.

In FIG. 9, a sectional view analogous to FIG. 4 is illustrated, but during the transition from the support position to the release position of the support ring 24.

As can be seen, the support ring 24 moves in the axial direction along the arrow P plotted in FIG. 9, driven by an actuator (not shown) that moves the support ring 24 axially by means of a lifting ring, for example.

Actuators of this type are generally known, and reference is made to the exemplary configuration according to WO 2017/174641 A1.

Hereinafter, the mode of operation of the belt retractor 10 according to the invention shall be explained in greater detail.

FIG. 10 illustrates a further sectional view of the belt retractor 10 according to the invention in which the support ring 24 is in its support position and the load-transmitting latches 20 are in their coupling position.

FIG. 11 shows a cross-section along the plane B-B of FIG. 10 to emphasize the relative position of the load-transmitting latches 20 and the contact projections 26 within the respective cutout 38.

When a webbing 58 of the belt retractor 10 is extracted, torques can be transmitted by the contact between the belt reel 12, specifically the extension 30 of the belt reel 12 and the holding portion 28 of the support ring 24, the contacts between the support ring 24 and the load-transmitting latches 20 and the contacts between the load-transmitting latches 20 and the load limiter 16.

If the actuator (not shown) is triggered, the support ring 24 is displaced by the actuator axially away from the belt reel 12 out of the support position into the release position via a release distance.

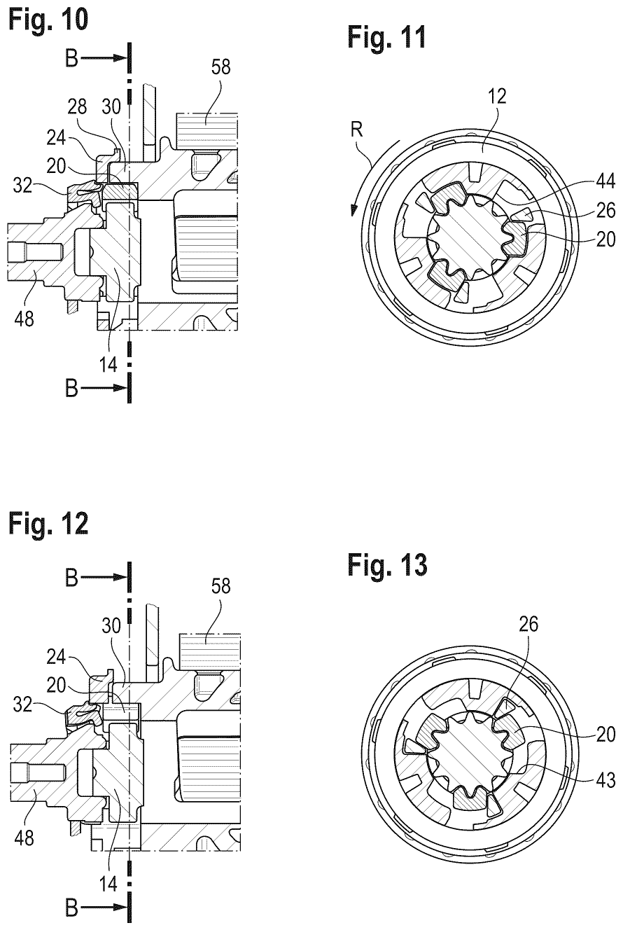

FIG. 12 shows a sectional view analogous to FIG. 10 during this operation.

It can be seen that the support ring 24 is lifted so far that no more contact is provided between the extension 30 and the circumferential holding portion 28 of the support ring 24.

At the same time, a movement of rotation of the load-transmitting latches 20 and the related contact projections 26 within the respective cutout 38 is triggered along the direction of rotation R shown in FIG. 11, causing the load-transmitting latches 20 to move away from the first sidewall 43 of the respective cutout 38.

Once the latch 20 is rotated so far that its surface previously situated on the first sidewall 43 reaches an enlarged area 60 of the cutout 38 which has a larger radial expansion than the area of the holding fixture in which the load-transmitting latch 20 is received in its coupling position, the load-transmitting latch 20 is displaced radially outwardly so that the tip 22 of the respective load-transmitting latch 20 is no longer in contact with the driving teeth 23 of the torsion rod 14. Thus, the load-transmitting latch 20 has reached its decoupling position.

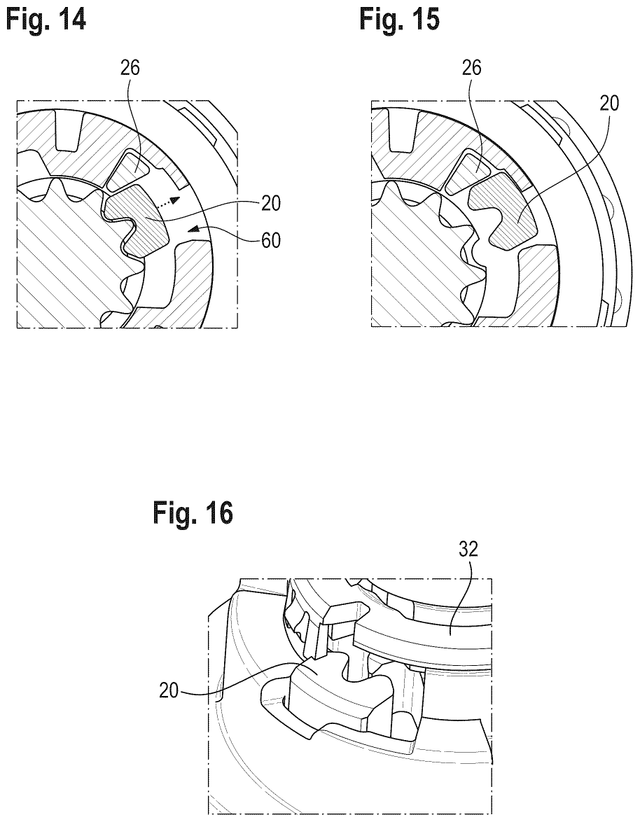

This transition is shown in the detailed views of FIGS. 14 and 15.

The resulting end position of the load-transmitting latch 20 inside the cutout 38 is further demonstrated in a perspective view in FIG. 16, where the representation of the contact projection 26 was omitted for reasons of clarity.

According to the invention, in the occurring radial movement of the load-transmitting latches 20, due to the axial expansion of the contact projections 26 of the support ring 24, the load-transmitting latches 20 are prevented from tilting so that a particularly reliable mechanism is resulting which also enables the use of larger torsion rods 14 or of load limiters 16 which generate a particularly high torque.

1-10. (canceled)

11. A belt retractor comprising a frame, a belt reel (12) arranged rotatably in the frame, a locking mechanism by which the belt reel (12) can be locked in the frame, and a load limiter which is releasably coupled to the belt reel (12),
wherein for coupling the load limiter at least one load-transmitting latch (20) is provided which is arranged on the belt reel (12) and is held in a coupling position by a support ring (24), wherein the support ring (24) can be moved out of a support position into a release position using an actuator, wherein
the support ring (24) includes a contact projection (26) associated with the load-transmitting latch (20) on the side of which the load-transmitting latch (20) abuts with a contact face (56), the contact projection (26) having an expansion in the axial direction which at least corresponds to the expansion of the contact face (56) in the axial direction.

12. The belt retractor according to claim 11, wherein the whole contact face (56) of the load-transmitting latch (20) abuts on the associated contact projection (26).

13. The belt retractor according to claim 11, wherein the load-transmitting latch (20) and the associated contact projection (26) of the support ring (24) are arranged in a cutout (38) on the belt reel (12).

14. The belt retractor according to claim 13, wherein the belt retractor (10) is arranged to displace the load-transmitting latch (20) radially inside the cutout (38) using the load limiter, once the support ring (24) is moved out of a support position toward a release position.

15. The belt retractor according to claim 11, wherein plural load-transmitting latches (20) are provided and the support ring (24) for each of the load-transmitting latches (20) has a contact projection (26) associated with the respective load-transmitting latch (20).

16. The belt retractor according to claim 15, wherein the plural load-transmitting latches (20) are arranged symmetrically.

17. The belt retractor according to claim 11, wherein the support ring (24) includes at least one circumferential holding portion (28) by which the support ring (24) is fastened in the support position to an extension (30) of the belt reel (12).

18. The belt retractor according to claim 11, wherein a holding ring (32) is provided which maintains the support ring (24) in the support position, the support ring (24) including at least one fastening projection (35) that engages in an associated holding fixture (34) of the holding ring (32).

19. The belt retractor according to claim 11, wherein the load limiter in the support position of the support ring (24) is connected to the belt reel (12) via the load-transmitting latch (20) for transmitting a torque and in the release position of the support ring (24) has no contact to the load-transmitting latch (20).

20. The belt retractor according to claim 11, wherein the support ring (24) has a symmetric design.
